(19) United States
(12) Patent Application Publication
(10) Pub. No.: US 2025/0316469 A1
(43) Pub. Date: Oct. 9, 2025

(54) AIR-TIGHT AMBIENT MASS SPECTROMETRY

(71) Applicant: Ohio State Innovation Foundation, Columbus, OH (US)

(72) Inventors: Abraham BADU-TAWIAH, Columbus, OH (US); Taghi SAHRAEIAN, Brookline, MA (US); Yiying WU, Columbus, OH (US); Christopher HADAD, Dublin, OH (US); Remy LALISSE, Pittsburgh, PA (US); Jingfeng ZHENG, Shanghai (CN)

(21) Appl. No.: 18/865,208

(22) PCT Filed: May 12, 2023
(86) PCT No.: PCT/US2023/022045

§ 371 Date: Nov. 12, 2024

Related U.S. Application Data
(60) Provisional application No. 63/341,049, filed on May 12, 2022.

(51) Int. Cl. H01J 49/04; G01N 27/623; H01J 49/00

(52) U.S. Cl. CPC H01J 49/0459; G01N 27/623; H01J 49/0031; H01J 49/004

(57) ABSTRACT

In an aspect, the present disclosure relates to a method. In one implementation, the method includes providing a material in an air-tight chamber defining an inlet and an outlet; supplying a direct current voltage to an electrode proximate to the material to generate ions in the air-tight chamber; introducing a carrier gas to the air-tight chamber at the inlet; and collecting the carrier gas and the ions at the outlet.

### CROSS-REFERENCE TO RELATED APPLICATION

This application claims the benefit of U.S. Provisional Application 63/341,049, filed on May 12, 2022, the contents of which is hereby incorporated in their entirety.

### STATEMENT REGARDING GOVERNMENT SUPPORT

This invention was made with government support under grant/contract number DE-SC0022097 awarded by the Department of Energy. The government has certain rights in the invention.

### BACKGROUND

The present disclosure generally relates to mass spectrometry. Most air-sensitive materials are prepared under vacuum in a glovebox. Characterization of the as-prepared material is challenging because it needs to be transferred to another laboratory during which the material can decompose and change identity. Even when transferred properly, most analytical methods (e.g., NMR and MS) require the application of solvent which causes chemical reactions to change the structure of the material. It is with respect to these and other considerations that certain embodiments of the present disclosure are presented.

### SUMMARY

In accordance with the purposes of the disclosed devices and methods as embodied and broadly described herein, the disclosed subject matter relates to air tight chambers for material analysis, and methods of use thereof.

In some aspects, the techniques described herein relate to a method including: providing a material in an air-tight chamber defining an inlet and an outlet; supplying a direct current voltage to an electrode proximate to the material to generate ions in the air-tight chamber; introducing a carrier gas to the air-tight chamber at the inlet; and collecting the carrier gas and the ions at the outlet.

In some aspects, the techniques described herein relate to a method, wherein the method further includes performing a mass spectrometry analysis on the ions collected at the outlet.

In some aspects, the techniques described herein relate to a method, further including characterizing, based on the mass spectrometry analysis, an elemental composition and structure of the material.

In some aspects, the techniques described herein relate to a method, further including determining a chemical composition of solid electrolyte interphase generated from a Lithium-Ion battery.

In some aspects, the techniques described herein relate to a method, wherein the material includes a thin-film organic-based magnetic material.

In some aspects, the techniques described herein relate to a method, wherein the material includes small organic compounds.

In some aspects, the techniques described herein relate to a method, further including determining a chemical composition of the small organic compounds.

In some aspects, the techniques described herein relate to a method, wherein the small organic compound includes an illicit drug.

In some aspects, the techniques described herein relate to a method wherein the illicit drug is cocaine.

In some aspects, the techniques described herein relate to a method wherein the small organic compound is not air sensitive.

In some aspects, the techniques described herein relate to a method, wherein the carrier gas is an inert gas.

In some aspects, the techniques described herein relate to a method, wherein the inert gas is helium.

In some aspects, the techniques described herein relate to a method, wherein the direct current voltage is approximately 1.8 kV.

In some aspects, the techniques described herein relate to a method, wherein the electrode includes a triangular tip.

In some aspects, the techniques described herein relate to a method, wherein the material is triangular.

In some aspects, the techniques described herein relate to a system for performing direct analysis of a material, the device including: an air-tight chamber defining an inlet and an outlet, wherein the air-tight chamber is configured to hold the material, wherein the inlet is configured to introduce a gas into the air-tight chamber, and wherein the outlet is configured to collect gasses and ions from the air-tight chamber; and an electrode positioned inside the air-tight chamber and configured to configured to be proximate to the material to generate ions in the air-tight chamber when a direct current voltage is applied to the electrode.

In some aspects, the techniques described herein relate to a system, wherein the system is configured to output the ions collected at the outlet to a mass spectrometer.

In some aspects, the techniques described herein relate to a system, wherein the mass spectrometer is configured to characterize, based on an output of the mass spectrometer, an elemental composition and structure of the material.

In some aspects, the techniques described herein relate to a system wherein the mass spectrometer is configured to determine a chemical composition of solid electrolyte interphase generated from a Lithium-Ion battery.

In some aspects, the techniques described herein relate to a system, wherein the material includes a thin-film organic-based magnetic material.

In some aspects, the techniques described herein relate to a system, wherein the material includes small organic compounds.

In some aspects, the techniques described herein relate to a system, wherein the system is configured to determine a chemical composition of the small organic compounds.

In some aspects, the techniques described herein relate to a system, wherein the small organic compound includes an illicit drug.

In some aspects, the techniques described herein relate to a system wherein the illicit drug is cocaine.

In some aspects, the techniques described herein relate to a system, wherein the small organic compound is not air sensitive.

In some aspects, the techniques described herein relate to a system, wherein the direct current voltage is approximately 1.8 kV.

In some aspects, the techniques described herein relate to a system, wherein the electrode includes a triangular tip.

In some aspects, the techniques described herein relate to a system, wherein the material is triangular.

In some aspects, the techniques described herein relate to a system, wherein the electrode is configured to non-destructively analyze the material.

Additional advantages of the disclosed devices and methods will be set forth in part in the description which follows, and in part will be obvious from the description. The advantages of the disclosed devices and methods will be realized and attained by means of the elements and combinations particularly pointed out in the appended claims. It is to be understood that both the foregoing general description and the following detailed description are exemplary and explanatory only and are not restrictive of the disclosed devices and methods, as claimed.

The details of one or more embodiments of the invention are set forth in the accompanying drawings and the description below. Other features, objects, and advantages of the invention will be apparent from the description and drawings, and from the claims.

### BRIEF DESCRIPTION OF THE FIGURES

FIG. 1A illustrates a Schematic showing characterization problems in mass spectrometry.

FIG. 1B illustrates a comparison of mass spectrometry techniques.

FIG. 1C illustrates a flowchart of a method for performing mass spectrometry according to an example implementation of the present disclosure.

FIG. 2 illustrates a device for direct analysis of a material, according to an example implementation of the present disclosure.

FIG. 3A illustrates example results of positive-ion mode mass spectra for a standard LEMC deposited on pristine graphite.

FIG. 3B illustrates example results of positive-ion mode mass spectra for cycled graphite electrode with established SEI layer

FIG. 3C illustrates example results of positive-ion mode mass spectra for pristine graphite electrode only with LP30 electrolyte wetting the surface

FIG. 4A illustrates example DFT calculations for optimized LEMC (m/z 113) structure and several possible pathways leading to species at (A) 69 and 157 m/z.

FIG. 4B illustrates example DFT calculations for optimized LEMC (m/z 113) structure and several possible pathways leading to species at (B) 95 and 183 m/z.

FIG. 4C illustrates the relative free energies of species involved are shown corresponding to their m/z calculated at the B3LYP/6-311+G(d,p) level of theory in the gas phase.

FIG. 4D illustrates an example method of synthesizing LEMC.

FIG. 5 illustrates powder XRD results of the synthesized LEMC, according to an example implementation described herein.

FIG. 6 illustrates a schematic for preparation of cycled graphite electrode sample, according to an example implementation described herein.

FIG. 7 illustrates cycling performance of graphite electrolyte using 1 M LiPF6 EC/DMC (vol % 50:50) with a current density of 0.25 C, according to an example implementation described herein.

FIG. 8 illustrates an experimental test of air sealing of an example MS sample chamber, according to an example implementation described herein.

FIG. 9 illustrates experimental results of voltage optimization of an example air-tight ambient MS methodology where the optimum voltage is about 1.8 kV, according to an example implementation described herein.

FIG. 10 illustrates isotope distributions of Lithium (Li) for detected species after battery cycling by airtight ambient MS. Li has two naturally-occurring stable isotopes, 6Li (7.5%) and 7Li (92.5%), according to an example implementation described herein.

FIG. 11A illustrates tandem mass spectra analysis of pristine (non-cycled) graphite electrode for low abundance peaks at m/z 113, according to an example implementation described herein.

FIG. 11B illustrates tandem mass spectra analysis of pristine (non-cycled) graphite electrode for low abundance peaks at m/z 183, according to an example implementation described herein.

FIG. 12A illustrates Positive mass spectra analysis of a plain copper triangle without graphite or battery cycling, according to an example implementation described herein.

FIG. 12B illustrates Positive mass spectra analysis of a plain copper triangle without Graphite electrode without electrolyte, according to an example implementation described herein.

FIG. 13A illustrates positive mass spectra analysis of cycled graphite electrode under ambient conditions without using air-tight container immediately or within two minutes of exposure of the sample to ambient air (all related peaks to LEMC are present).

FIG. 13B illustrates positive mass spectra analysis of cycled graphite electrode after longer (>2 min) exposure times.

FIG. 14 illustrates an example mass spectrum recorded on an ion trap mass spectrometer after a cocaine sample was placed on a copper surface and a 2.1 kV DC voltage was applied.

### DETAILED DESCRIPTION

The present disclosure, in accordance with some aspects and in some embodiments, relates to a device and method for mass spectrometry (MS) for direct analysis of air-sensitive and water-sensitive materials. In some embodiments, a device can be placed inside the glovebox, and the prepared material safely transported in air under air-tight conditions without chemical decomposition. Then, mass spectrometry analysis of the material can be performed directly from the device under solvent-free conditions. Molecule-level information can thereby be obtained that can characterize the elemental composition and structure of the material. Methods according to some aspects and embodiments of the present disclosure are non-destructive.

According to one example implementation, the device and method can be implemented to decisively determine the chemical composition of solid electrolyte interphase generated from Lithium-Ion batteries. However, the present disclosure is not limited to such implementations. For example, a method according to some embodiments can be applied to many other air-sensitive materials and provide molecular level information that is currently not possible using conventional devices and methods.

Numerous characteristics and advantages provided by aspects of the present disclosure have been set forth in the foregoing description and are set forth in the attached Appendix A and Appendix B, together with details of structure and function. The patentable scope of certain embodiments is set forth in the appended claims and claims of non-provisional patent application(s) to be filed claiming priority to the present Application. While the present disclosure is disclosed in several forms, it will be apparent to those skilled in the art that many modifications can be made therein without departing from the spirit and scope of the present disclosure and its equivalents. Therefore, other modifications or embodiments as may be suggested by the teachings herein are particularly reserved.

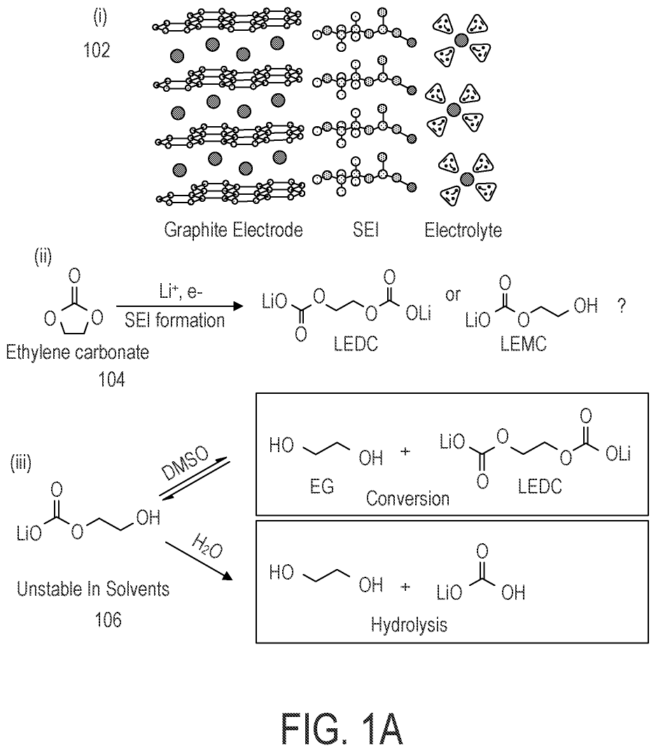

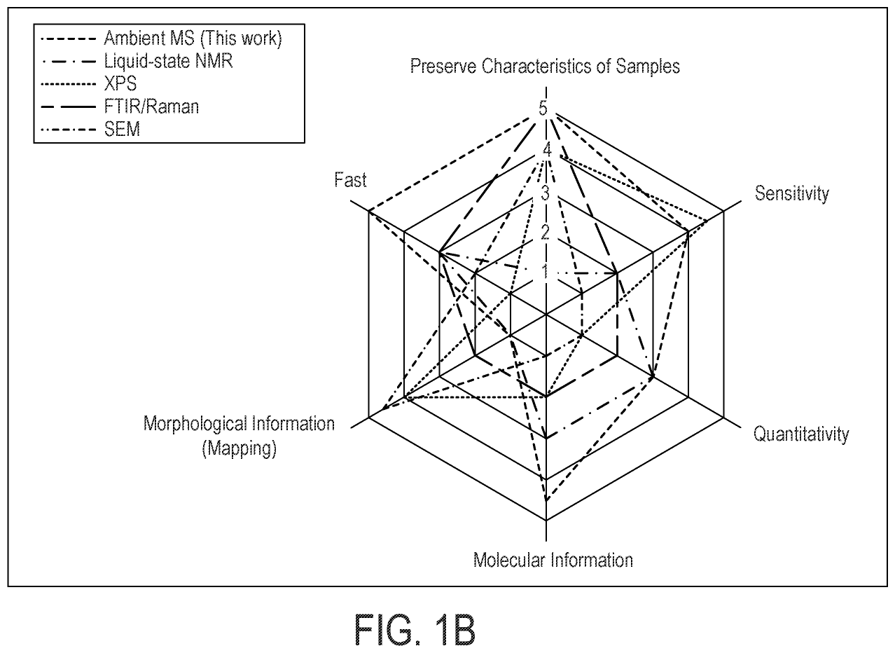

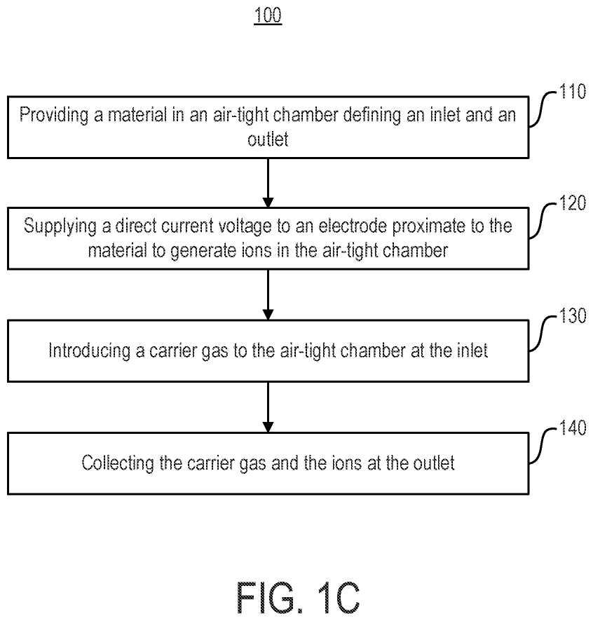

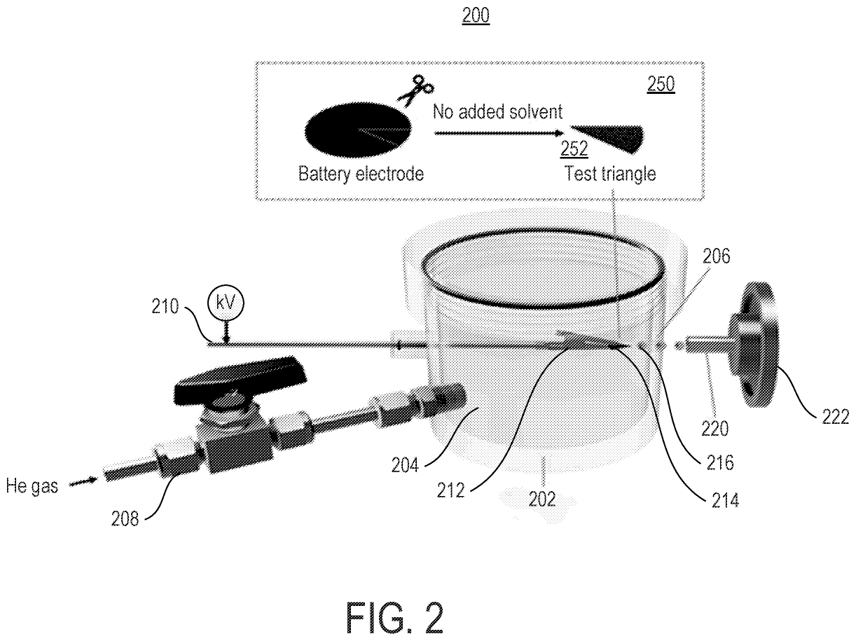

An example method 100 for performing air-tight ambient mass spectrometry is illustrated in FIG. 1C. It should be understood that the example method 100 can optionally be performed using the system 200 described with reference to FIG. 2

At step 110, the method 100 can include providing a material in an air-tight chamber defining an inlet and an outlet.

At step 120, the method 100 can include supplying a direct current voltage to an electrode proximate to the material to generate ions in the air-tight chamber. The electrode can optionally include a triangular tip. Alternatively or additionally, the material can be triangular. Optionally, the direct current voltage can be approximately 1.8 kV, but it should be understood that this is only a non-limiting example, and that any of the voltages described herein can be applied at step 120.

At step 130 the method can further include introducing a carrier gas to the air-tight chamber at the inlet. The carrier gas can optionally be an inert gas. A non-limiting example of an inert gas is helium.

At step 140 the method can further include collecting the carrier gas and the ions at the outlet. Optionally, the method 100 can further include performing a mass spectrometry analysis on the ions collected at the outlet. Alternatively or additionally, the method 100 can further include characterizing, based on the mass spectrometry analysis, an elemental composition and structure of the material. Optionally, the method can include determining a chemical composition of solid electrolyte interphase generated from a Lithium-Ion battery.

The present disclosure contemplates that different materials can be analyzed using implementations of the method 100. In some implementations the material includes a thin-film organic-based magnetic material. Alternatively or additionally, in some implementations, the material includes small organic compounds. Optionally, the method can include determining a chemical composition of the small organic compounds. As non-limiting examples, the small organic compound can be an illicit drug (e.g., cocaine). Alternatively or additionally, the small organic compound can be air sensitive or not air sensitive.

An example system 200 for performing air-tight ambient mass spectrometry is illustrated in FIG. 2.

The system 200 includes an air-tight chamber 202. The airtight chamber includes an inlet 204 and an outlet 206. The inlet 204 can optionally be connected to a valve 208 configured to control the flow of a carrier gas (e.g., an inert gas like helium).

The system 200 can further include an electrode 210 that can extend into the air-tight chamber 202. The electrode 210 can optionally include a tip 212 or other attachment device configured to hold a material 214. When a current/voltage is applied to the electrode 210 and/or tip 212, the current can pass into the material 214 causing ionization of the material. The ions 216 can be carried by the carrier gas input into the outlet 206 of the air-tight chamber 202. The flow of the carrier gas can cause the ions 216 to exit the outlet 206.

Optionally, the direct current voltage is applied to the electrode in an amount sufficient to ionize at least a portion of the material (e.g., at least one organic compound). For instance, the applied voltage can be at least about 0.5 kV, at least about 1.0 kV, at least about 1.5 kV, at least about 2.0 kV, at least about 2.5 kV, at least about 3.0 kV, at least about 3.5 kV, at least about 4.0 kV, at least about 4.5 kV, at least about 5.0 kV, at least about 6.0 kV, at least about 7.0 kV, at least about 8.0 kV, at least about 9.0 kV, or at least about 10.0 kV. In certain embodiments, the applied direct current voltage can be from 0.5-15 kV, from 0.5-10 kV, from 1-15 kV, from 1-10 kV, from 1-5 kV, from 2-10 kV, from 2-7 kV, or from 2-5 kV. In some implementations, the direct current voltage is approximately 1.8 kV.

As shown in FIG. 2, the outlet 206 can optionally be connected to the inlet 220 of a mass spectrometer 222. The mass spectrometer 222 can then perform mass spectrometry on the ions 216.

In certain aspects, the tip 212 and/or the material 214 can be in the shape of a triangle, including equilateral, isosceles, and scalene triangles. The tip 212 can serve to direct the ionized compounds toward the outlet of the air-tight chamber 202 and into the mass spectrometer 222 or any other detector.

Although any type of triangle may be employed, in some implementations it is

preferred that the triangle is an isosceles triangle. For isosceles substrates, the apex angle can be from 5°-45°, from 10°-40°, from 15°-40°, from 20°-40°, from 25°-40°, from 30°-40°, 5°-35°, from 10°-35°, from 15°-35°, from 20°-35°, from 25°-35°, from 30°-35°, from 5°-25°, from 10°-25°, from 15°-25°, or from 20°-25°. In some embodiments, the height (i.e., the length to perpendicular bisector to the base) can be at least 150% the length of the base, at least 175% the length of the base, at least 200% the length of the base, at least 225% the length of the base, at least 250% the length of the base, at least 275% the length of the base, or at least 300% the length of the base. In certain embodiments, the height of the triangle can be from 100-300% the length of the base, from 100-250% the length of the base, from 100-200% the length of the base, from 100-150% the length of the base, from 150-300% the length of the base, from 150-250% the length of the base, or from 200-250% the length of the base.

The system 200 illustrated in FIG. 2 can perform any of the methods described with reference to FIG. 1C. As described with reference to FIG, the system 200 can be configured to enable a mass spectrometer to characterize, the elemental composition and structure of the material 214.

In some implementations, the system 200 can be used to determine the chemical composition of solid electrolyte interphase generated from a Lithium-Ion battery.

Optionally, the material 214 can include a thin-film organic-based magnetic material.

Alternatively or additionally, the material 214 can include small organic compounds and/or the system 200 can be configured to determine the chemical composition of the small organic compounds. Non-limiting examples of small organic compounds include common illicit drugs, and in some implementations, for example, the illicit drug is cocaine. Other examples of organic compounds include compounds that are not air sensitive. In some implementations, the system 200 and/or electrode 210 can be configured to non-destructively analyze the material.

The formation of a stable solid electrolyte interphase (SEI) at graphite electrode is necessary for Li-ion batteries (LIB) to prevent excessive degradation of electrolytes. The exact organic composition of SEI has not previously been decisively determined with lithium ethylene mono-carbonate (LEMC) being one of the debated components. An air-tight ambient mass spectrometry (MS) platform is developed to directly characterize the air-sensitive organic components present in SEI. Ionization occurs via a solvent-free field induced process at atmospheric pressure. Our experimental data,based on tandem MS analysis, revealed LEMC to be the major organic component in SEI. This result resolves a long-standing mystery surrounding the composition of native SEI in LIB, where no trace of the other debated compound, lithium ethylene dicarbonate, was detected. The energetics of fragmentation of LEMC and the corresponding stabilities of various ionic species detected during the air-tight ambient MS analysis were calculated using density functional theory (DFT). Our findings confirmed favorable protonation energies and suggested the molecular structures for many of the detected species. Solvent (i.e., ethylene carbonate)-induced stabilization effects observed during the ionization process were also confirmed by DFT. The reported study encourages the routine use of ambient mass spectrometry to characterize both anodic and cathodic electrodes of all battery types as well as to study other air-sensitive materials in their native state.

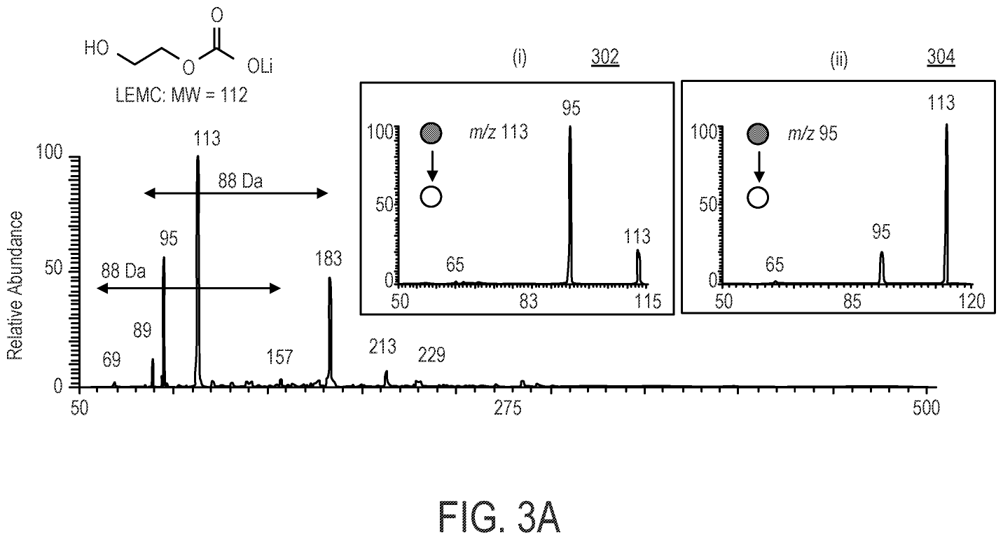

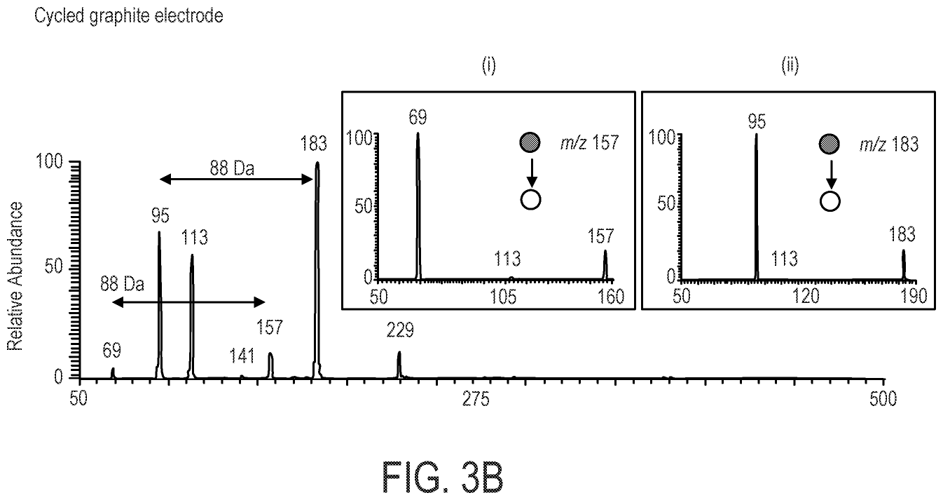

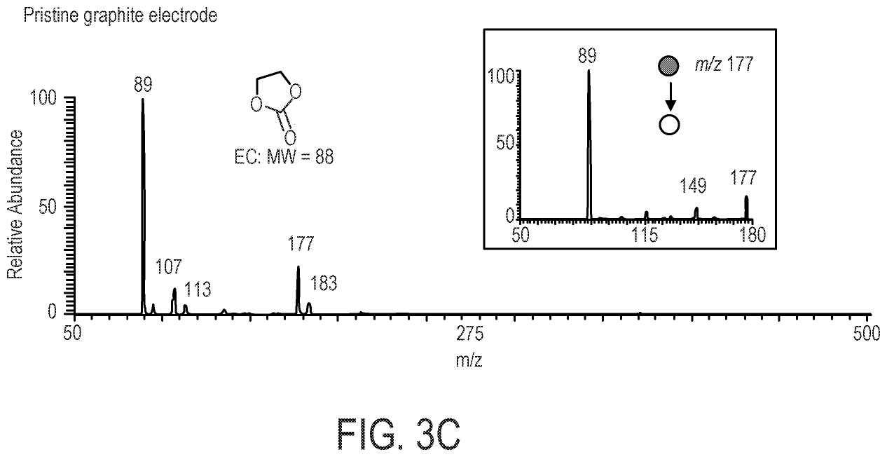

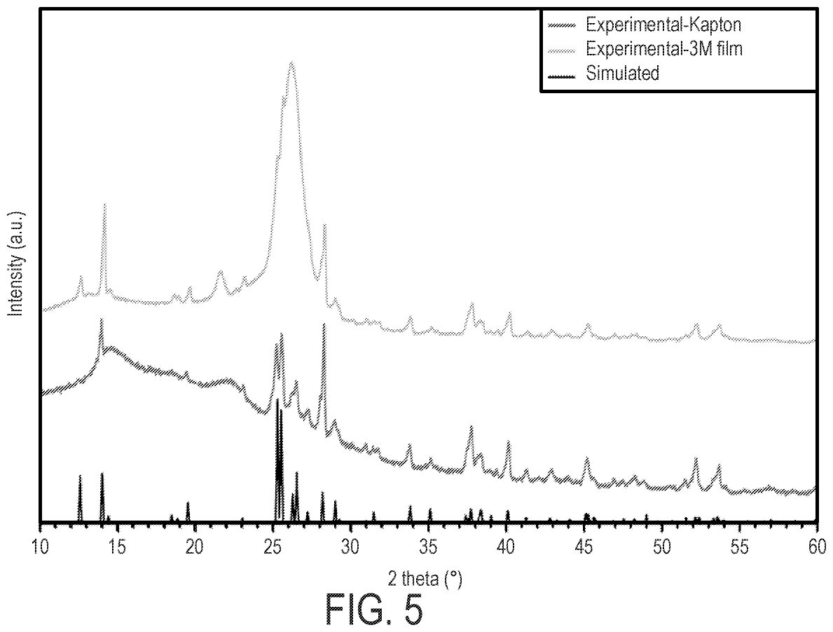

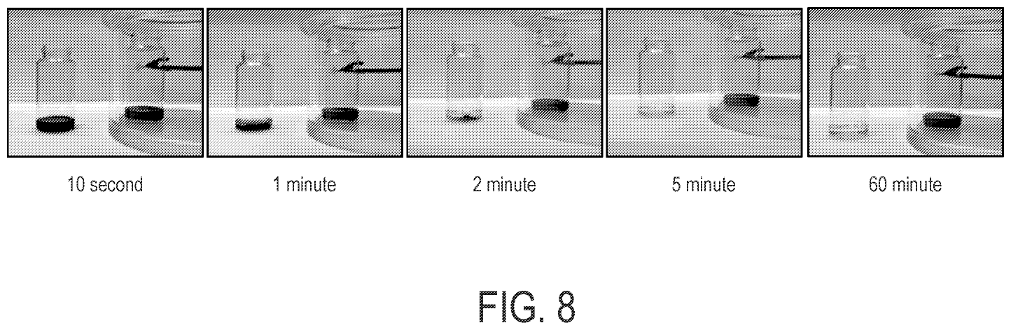

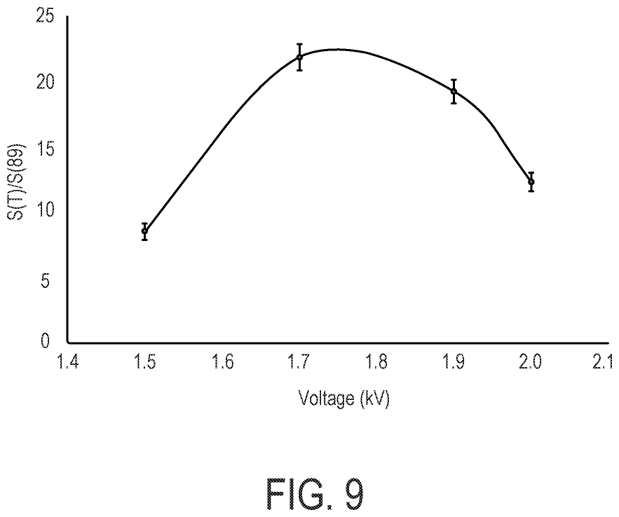

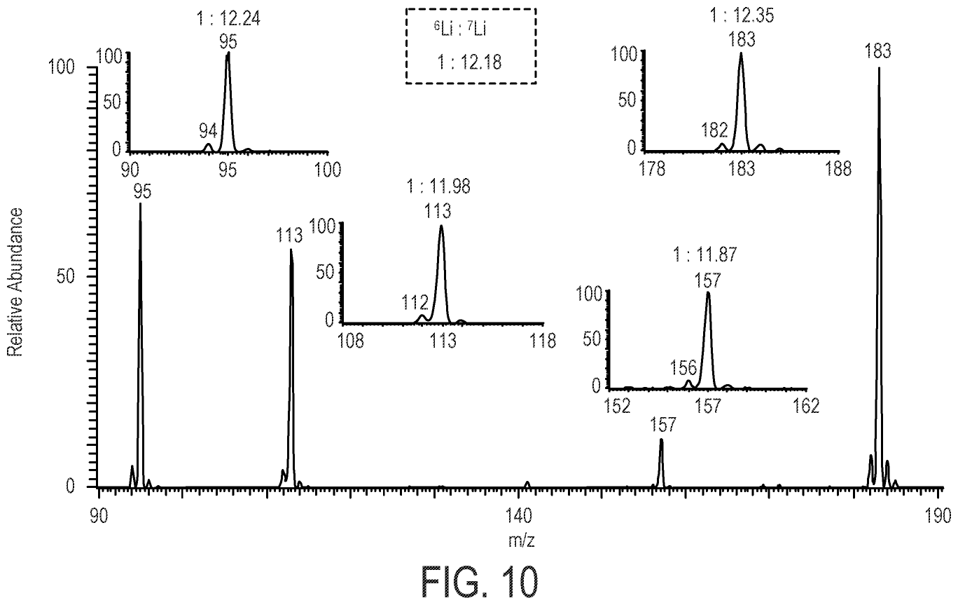

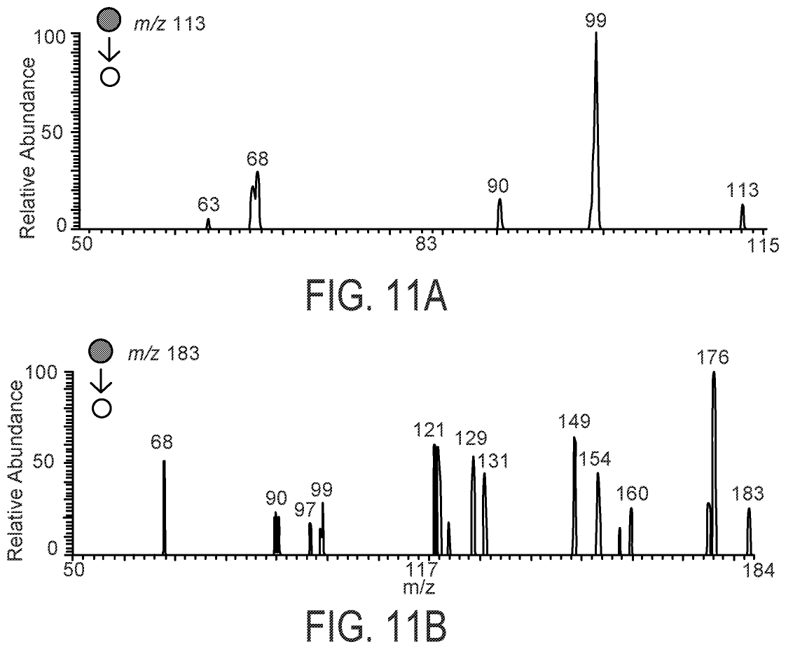

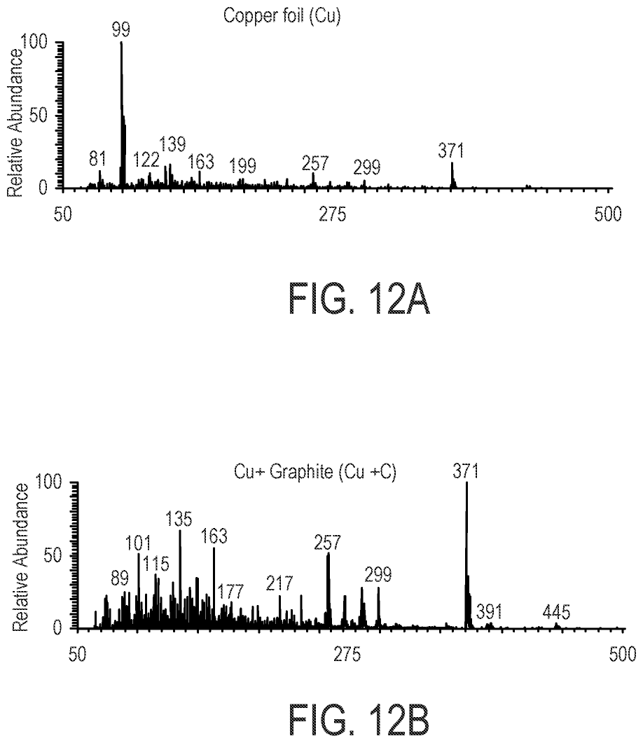

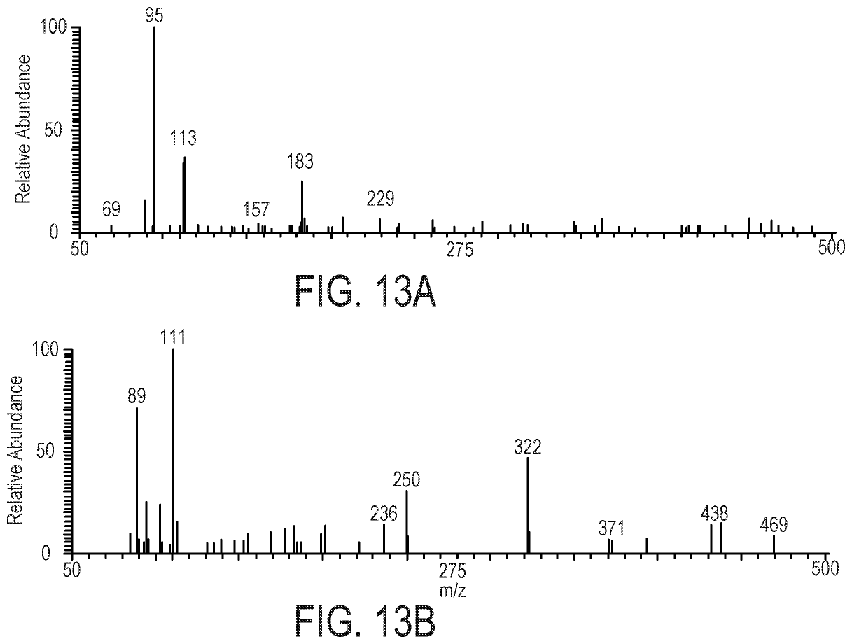

Graphite intercalation represents a cornerstone in the development of Li-ion batteries. During the first few charge/discharge cycles, electrolytes are electrochemically reduced on the surface of graphite, forming a solid-electrolyte interphase (SEI) as shown in panel 102 in FIG. 1A. A commonly used electrolyte includes LiPF6 (1 M) in a mixture of ethylene carbonate (EC) and dimethyl carbonate (DMC). The as-formed SEI layer is generally ˜10 to 50 nm thick, contains inorganic salts (e.g., Li2CO3 and LiF) close to the electrode and degraded carbonate molecules (e.g., semi-carbonates and polymers) close to the electrolyte.[1] An ideal SEI layer prevents further electrolyte degradation by acting as an electronic insulator while facilitating Li+ transport. Analysis of the SEI layer is challenging due to the physical (ultra-thin) and chemical complexities. Additional complications come from its sensitivity to moisture and oxygen, including changing of its chemical composition within minutes upon exposure to water and/or air. An ideal technique for SEI characterization should satisfy six prerequisites listed in the spider plot in FIG. 1B. One such prerequisite is that sample preparation and analysis should not change the characteristic of the SEI layer. For instance, solvent used in nuclear magnetic resonance (NMR) experiments may trigger chemical conversion of SEI components. In this case, a technique capable of direct analysis with minimum sample preparation would be most useful. Also, the technique needs to be fast and sensitive, while providing molecular-level and morphological information. For instance, surface sensitive X-ray photoelectron spectroscopy (XPS) can only provide information regarding the bonding environment of elements present in a sample. Therefore, although a large variety of analytical techniques, ranging from surface to bulk analysis techniques, such as XPS[2], Raman[3], Fourier transform infrared (FT-IR)[4], X-ray powder diffraction (XRD)[5], mass spectrometry (MS)[6], and NMR[1d], have been used to characterize SEI, the true composition and structure of the SEI remain elusive. MS is a sensitive analytical technique, which directly provides molecular weight and structural information. MS has been applied to study the electrolyte evolution in electrode-electrolyte interphase and in electrolytes.[6] Ambient ionization techniques such as desorption electrospray ionization (DESI)[6c,7], and low temperature plasma (LTP)[8] allow direct surface analysis under ambient conditions without prior sample treatment. In 2016, Liu and co-workers applied DESI-MS to characterize SEI and cathode-electrolyte interphase (CEI).[6c] In their study, cycled working electrodes were tested without any treatment, which exclude any possible changes during the analysis process. However, their work suffers from two important shortcomings: first, acetonitrile, used as the DESI spray solvent, may cause changes in SEI composition; and second, the SEI sample was left in open air during DESI-MS analysis, which may cause unwanted sample oxidation or hydrolysis. In the current study, we developed an ambient ionization platform that can be performed both in ambient air and under airtight conditions. We have applied this platform to analyze the SEI layer with no sample preparation and more importantly no additional solvent is needed. This allows us to investigate debated SEI compositions and to discover new insights. One notable example is the organic degradation product from EC. In general, it is commonly believed that lithium ethylene dicarbonate LEDC 104 illustrated in FIG. 1A, generated from the reduction of EC, is the main organic component in SEI. However, a recent study by Wang and co-workers suggested that the previously reported synthesized LEDC standard is indeed lithium ethylene mono-carbonate 104 illustrated in FIG. 1B C).[1d] LEMC, instead of LEDC, is more likely to be the main SEI component. In Wang's study, NMR spectroscopic studies, using either DMSO or D2O as solvents, compared the SEI layer to standards of LEMC and LEDC. However, LEMC and LEDC are involved in complex equilibria that allow rapid interconversions in DMSO and hydrolysis in D2O 106 illustrated in FIG. 1A. This instability and conversion in solvents make the analysis and subsequent interpretation of data derived from real SEI samples even more challenging. In 2020, Henschel and co-workers utilized 13C labeling of electrolyte components to study the electrochemical decomposition of electrolytes.[6d] The authors concluded that LEMC is an integral part of their proposed electrochemical degradation mechanism, although direct experimental evidence was lacking. Similarly, a recent study has used theoretical calculations to predict the presence of LEMC in SEI.[9] The example implementation described herein used a air-tight ambient MS method to characterize standard LEMC that was synthesized. The purity of the synthesized material was confirmed using powder X-ray diffraction as shown in FIG. 5. As mentioned herein, 1H NMR analysis failed to distinguish between the presence of LEMC from LEDC in the DMSO-d6 solvent, as also described by Wang et al.[1d] There can be advantages to avoiding the addition of solvents when characterizing LEMC. The example apparatus for performing solvent-free, air-tight direct ionization outside of the vacuum environment of the mass spectrometer is as shown in FIG. 2. The inset 250 illustrates an example ambient ionization process for direct sampling of the organic components in the Li-ion SEI using a test triangle 252. The cycled graphite electrode on which SEI is formed was cut into a sharp triangular tip and attached to an alligator clip. The application of direct current (DC) high voltage generates a sufficient electric field between the tip of the graphite triangle and the inlet of the mass spectrometer that causes the ejection and ionization of organic compounds present in the SEI. The test was performed using the designed air-tight sample holder to prevent the interference of oxygen and moisture on the samples. We determined, through extensive experiments, that samples kept in the air-tight container can be left for hours without oxidation/decomposition, as shown in FIG. 8. When ready for MS analysis, the whole container is placed in front of the mass spectrometer, and the front outlet is opened and aligned with the MS inlet, as shown in FIG. 2. Just before opening the front outlet, the gas inlet to the air-tight container is opened, and He gas (pressure: 5 psi, flow rate: 1 L/min) is employed to generate a positive pressure at the front outlet of the container to prevent air from entering it. The application of an optimized high voltage of 1.8 kV DC (FIG. 9) to the graphite triangle generates ions through a mechanism that we believe to involve the combination of field ionization and (micro) plasma ionization. It should be understood that 1.8 kV is a non-limiting example and that other voltages can be suitable for the ionization of different materials. The generated ions are then transferred through ambient air to the proximal mass spectrometer for in-situ structural characterization via tandem MS (MS/MS). FIG. 3A shows positive-ion mode mass spectrum recorded when the synthesized LEMC was deposited onto the surface of a graphite electrode. The electrolyte (LiPF6 in EC/DMC) should not introduce any chemical change in the composition of SEI layer and thus was used here to wet the graphite electrode before MS analysis. Electrolyte application and the preparation of graphite triangles, including attachment and placement into the air-tight container, were all performed inside an Ar-filled glovebox. Once inside the air-tight container, the samples can be transferred in ambient air without sample degradation. Upon the application of 1.8 kV, the study observed gas-phase ions that are directly related to LEMC (MW 112 Da). For example, the highly abundant peak registered at m/z 113 is assigned to protonated LEMC species, which readily loses water (MW 18 Da) and CO2 (MW 44 Da) during the ionization process to give peaks at m/z 95 and 69,respectively, in the single-stage full mass spectrum. The production MS/MS spectra for ions at m/z 113 and 95 are provided as insert 302 for m/z 113 and insert 304 for m/z 95, in FIG. 3A. As can be observed, the protonated LEMC fragments upon activation in collision-induced dissociation (CID) experiments performed under high vacuum environment of the mass spectrometer to yield fragment ions at m/z 95 (major) and 65 through the loss of water and formaldehyde (CH2-O; MW 30 Da), respectively (inset 302 in FIG. 3A). While CID of species at m/z 95 generated during the ionization process at atmospheric pressure fragmented by losing neutral formaldehyde to give ion at m/z 65, the same activation process was also found to facilitate a hydration reaction yielding a product ion at m/z 113 in the gas phase (inset 304 in FIG. 3A). These two tandem MS experiments confirm that the ions at m/z 113 and 95 generated during the airtight ambient MS experiments are related, both of which originate from the purely synthesized LEMC compound. Additional peaks were observed including peaks at m/z 157 and 183, which we ascribe to ethylene carbonate (MW 88 Da) solvent adducts of species at m/z 69 and 95, respectively. This assignment is confirmed by tandem MS experiments via CID in which ions at m/z 157 fragmented to give a predominant species at m/z 69 through the loss of neutral ethylene carbonate (inset 304 in FIG. 3B). Likewise, MS/MS at m/z 183 afforded a major fragment at m/z 95 via the loss of neutral ethylene carbonate (inset 304 in FIG. 3B). These species were also confirmed via the isotope distributions in the full mass spectra to contain Li, which involve Li-6 and Li-7 at ˜1:12 ratios (FIG. 10). After the analysis of the pure LEMC sample, we proceeded to apply the air-tight ambient MS platform to characterize the chemical composition of real SEI samples derived from cycling of Li-ion battery. The graphite electrode is the main component of interest. We used LP30 electrolyte which is a composition of 1 M LiPF6 EC/DMC (vol % 50:50). After battery cycling, the graphite attached to an alligator clip and inside the air-tight container. Here too, all assembly was done inside an Ar-filled glovebox with the aim to maintain SEI integrity before MS analysis. The positive-ion mode mass spectrum derived from the analysis of the cycled graphite electrode is shown in FIG. 3B. Compared with standard LEMC analysis (FIG. 3A), all of the expected LEMCrelated peaks were observed, including m/z 183, 157, 113, 95, and 69. MS/MS experiments confirmed identical structures, as previously deduced for the standard peaks. For purpose of comparison, we provide the mass spectrum (FIG. 3C) recorded from the analysis of graphite electrode, wetted with just LiPF6 in EC/DMC electrolyte, but without battery cycling. In this case, the air-tight ambient MS analysis showed peaks at m/z 89 and 177, corresponding to protonated EC and proton-bound dimer of EC, respectively. Low abundance peaks at m/z 113 and 183 were detected in the pristine graphite electrode; however, their MS/MS spectra illustrated in FIG. 11A (m/z 113) and FIG. 11B (m/z 183) did not match any of the diagnostic fragment ions expected for LEMC related peaks. We further performed two control experiments to investigate the effect of other constitutive parts of the Li-ion battery and SEI samples: analysis of Cu foil alone and dry pristine graphite electrode. The results of these control experiments are shown in FIG. 12A and FIG. 12B, which indicate that neither the Cu itself nor the addition of graphite on Cu produce interpretable peaks related to experiments where SEI was present on the cycled graphite electrode. The obvious chemical difference between spectra before and after cycling (despite common starting materials) confirm the well-known collective changes/reactions that occur to produce SEI during Liion battery cycling. Likewise, the high degree of similarities in chemical profiles between spectra derived from the standard LEMC and experimental samples provide strong evidence for the formation of LEMC as the main organic component in Li-ion SEI. We conducted similar MS analyses of the graphite electrode (with and without cycling) under ambient conditions, without the air-tight container. Under this experimental condition, the study observed the expected native SEI organic constituents immediately or within two minutes of exposure of the sample to ambient air (FIG. 13A). However, the expected diagnostic peaks disappeared after longer (>2 min) exposure times (FIG. 13B). This result is consistent with the fact that SEI is well known to be unstable in air/moisture, making the design and development of air-tight chamber both necessary and important. The chamber facilitates transport of sample between different laboratories enabling otherwise difficult collaborations to be achieved. With this air-tight MS platform, it is possible to analyze other air/moisture-sensitive samples in their native state. The study showed that the air-tight ambient ionization source works well at low He carrier gas flow rates (e.g., 1 L/min). Higher gas flow rates were observed to reduce signal-to-noise ratio due to the onset of discharge. Applied DC voltages greater than 1.8 kV also caused excessive discharge, which made it challenging to discern ion peaks due to organic species desorbed from the SEI. Lastly, the study used DFT (B3LYP/6-311+G(d,p)) calculations to evaluate possible MS fragmentation pathways of LEMC by computing the relative free energies of different thermodynamic pathways with

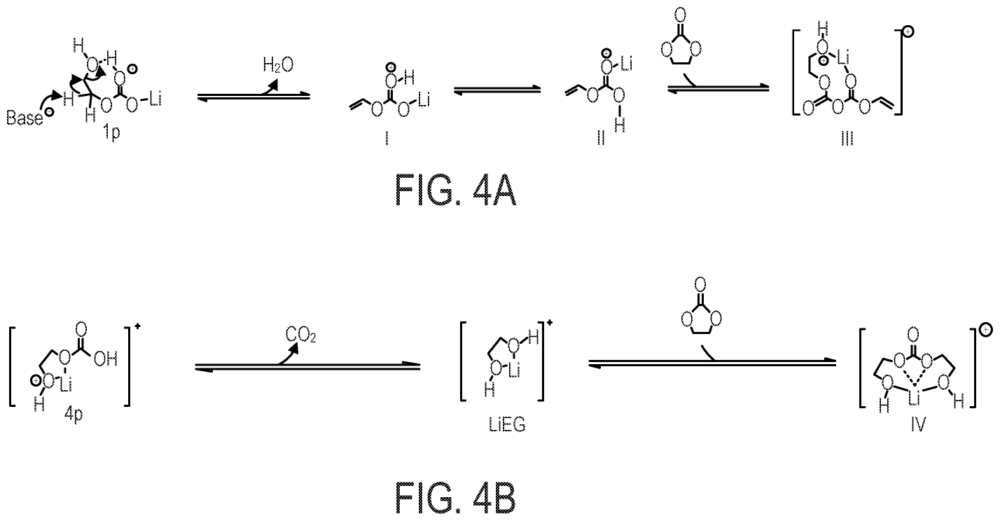

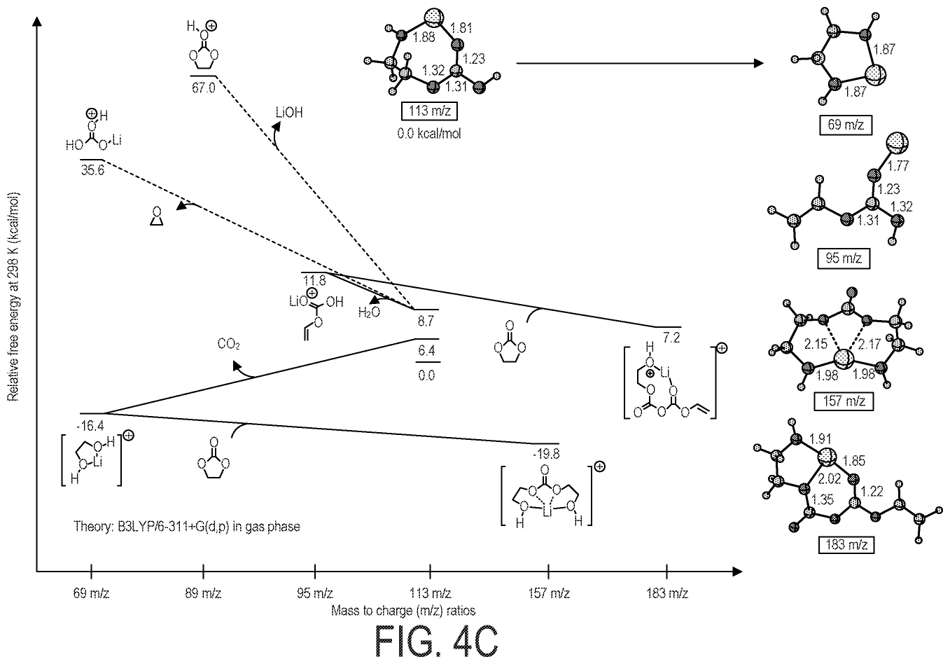

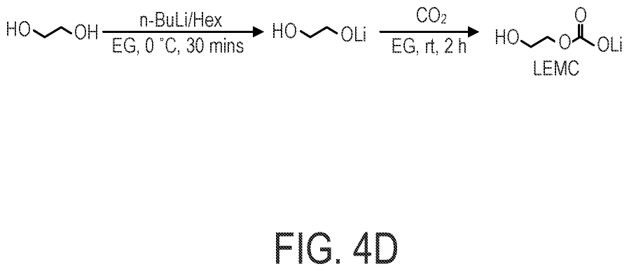

Gaussian. [10] The study sought to calculate the minimum energy required to cause the loss of water and CO2 from LEMC, and to investigate other possible fragmentation pathways that might favorably compete with the observed reactions. The optimized geometry of neutral LEMC showed stable structure in which the lithium is bonded between the end OH group and ether oxygen atom. This geometry leaves the carboxylic functional group free to engage in reactions. The proton affinity of the optimized LEMC structure was estimated to be 112.6 kcal/mol (4.88 eV). The fact that protonated LEMC species are detected with ease suggest that (i) field ionization is important in the process and/or (ii) the ionizing particles are highly acidic in nature, including the presence of low molecular weight protonated water clusters [H+ (H2O)n; n=1, or 2]. [11] Similarly, the optimized structure was used to calculate the ionization potential of LEMC, which was found to be 221.6 kcal/mol (9.61 eV). Note: typically, the breakdown of ambient air to generate corona discharge occurs when DC voltage >4 kV is applied. Electrons in such electrical discharge are found to have <9 eV of kinetic energy. The 1.8 kV DC voltage used in our experiment ensures that harsh corona discharge is avoided, suggesting that electron energies involved in our experiment are not sufficient to ionize LEMC. However, the numerous collisions occurring at atmospheric pressure can provide the critical energy (<4 eV for most organic compounds) needed to cause fragmentation of LEMC, as observed for the loss of water and CO2 neutral species. Example DFT calculations (shown in FIG. 4A) suggest that the loss of water from the protonated LEMC (m/z 113) gives species at m/z 95, which is only 11.8 kcal/mol (0.5 eV) less stable than the parent protonated ion (illustrated in FIG. 4A). Also, the fragment ion formed from the elimination of CO2 from protonated LEMC was found to be 16.4 kcal/mol more stable than the original protonated species at m/z 113 (illustrated in FIG. 4B). Possible fragmentation pathways of LEMC, its different reactions with other species, and their energetics were also studied. The release of ethylene oxide (MW 44 Da) from protonated LEMC is another possible pathway through which the species at m/z 69 can be formed (FIG. 4C). However, this pathway involving ethylene oxide generates ionic species that is 35.6 kcal/mol less stable than the parent protonated LEMC compound. The stability and energetics of the EC adducts at m/z 157 and 183 associated with species at m/z 69 and 95, respectively, were also investigated (FIGS. 4A-4C). That is, the attachment of EC solvent to ions at m/z 69 (at energy-16.4 kcal/mol, after loss of CO2 from protonated LEMC) produces species (m/z 157) of energy-19.8 kcal/mol. This means, the adduct formed between EC and ion at m/z 69 is approximately 20 kcal/mol more stable than the parent protonated LEMC. Likewise, the attachment of EC solvent to species at m/z 95 (at energy +11.8 kcal/mol, after loss of H2O from protonated LEMC) produces species (m/z 183) that is +7.2 kcal/mol less stable than the parent LEMC ion at m/z 113. Although results from the DFT calculations correlate well with species detected in our air-tight ambient MS platform, intensities of the species in the recorded mass spectra do not correspond directly to their abundance in the SEI or calculated energetics. This is because ion intensities are influenced by the intrinsic ionization efficiencies of each species, transfer efficiency from the graphite surface to the mass spectrometer, and mass range within which the specific ions are analyzed within the ion trap mass spectrometer. In summary, the solid electrolyte interphase is an integral part of the Li-ion batteries that can give important insight into the structure and dynamics at graphite electrode. In this study, we have shown that the debated species present in SEI layer at graphite electrode can be detected and characterized by a novel air-tight ambient mass spectrometry technique. In this case, we confirmed that lithium ethylene mono-carbonate is the main organic component as opposed to lithium ethylene dicarbonate. Our method avoids the use of reactive solvents (e.g., water and dimethyl sulfoxide), which typically trigger unwanted hydrolysis or equilibrium reaction that change the identity of the native sample. In addition, our method prevents exposure to ambient air during MS analysis by creating a positive pressure at the outlet of the airtight container. Collectively, the analytical method presented in this work enables novel measurements to be made, one that facilitates direct analysis of air-sensitive materials generating molecular information in a non-destructive and rapid manner. DFT analysis, predicting the relative thermodynamic stability of different molecules and ionic species, including fragments and adducts generated from the SEI, provide molecular-level structures that support the detected masses from the air-tight ambient mass spectrometry strategy. Thus, this mass spectrometric approach can afford predictable results. Therefore, we believe that the new MS platform can be applied to analyze other air-sensitive materials to advance important fundamental studies.

Air-tight ambient MS for direct analysis of battery graphite electrodes to unambiguously resolve the main component of the SEI layer, i.e., LEDC or LEMC. No solvent is used except of LP30 electrolyte for wetting the surface during preparation in glovebox. The optimized direct current (DC) voltage applied to the sample is 1.8 kV. The He gas (5 psi) with an optimum flow rate of 1 L/min is controlled by a flow meter. Density functional theory calculations provide molecular-level structures that support the detected masses from the air-tight ambient mass spectrometry strategy.

Example materials: 1M LiPF6 EC/DMC (vol % 50:50) electrolyte (LP30) was purchased from Gotion and used directly without further purification. Li chip (0.6 mm thickness) was purchased from MTI. Celgard separator was dried at 70° C. under vacuum using a chemical drier for two days before use. Coin cell cases, graphite electrodes were dried at 120° C. under vacuum using a chemical drier for two days before use. Graphite electrodes contain 80% graphite as the active material, 10% PVDF as the binder, 10% Super P as the conducting material on Cu foil as the current collector. The active material load is 1.2 mg cm-2. Instrument: Thermo Fisher Scientific linear ion trap mass spectrometer (San Jose, CA) was used. Optimized parameters for MS used were as follows: 200° C. capillary temperature, 3 microscans, 100 ms ion injection time, and 60% S-lens voltage. MS data collecting and processing were performed using the Thermo Fisher Scientific Xcalibur 2.2 SP1 software. Tandem MS with collision-induced dissociation was executed for the analyte identification.

Synthesis of LEMC: The synthesis of LEMC was performed. [1] The reaction is shown in FIG. 4D. Inside an Ar-filled glovebox, 8 mL 2.5 M mL n-BuLi/hexane (20 mmol) was dropwise added into 10 mL anhydrous EG. After 30 mins stirring, dry CO2 was bubbled through the previous suspension for 2 hours. Inside the glovebox, 50 mL pyridine was added into the solution. After two days, LEMC as white precipitate was formed, which was separated by centrifuge. The solid powder was washed with DMF and diethyl ether, then dried under vacuum to give the final product.

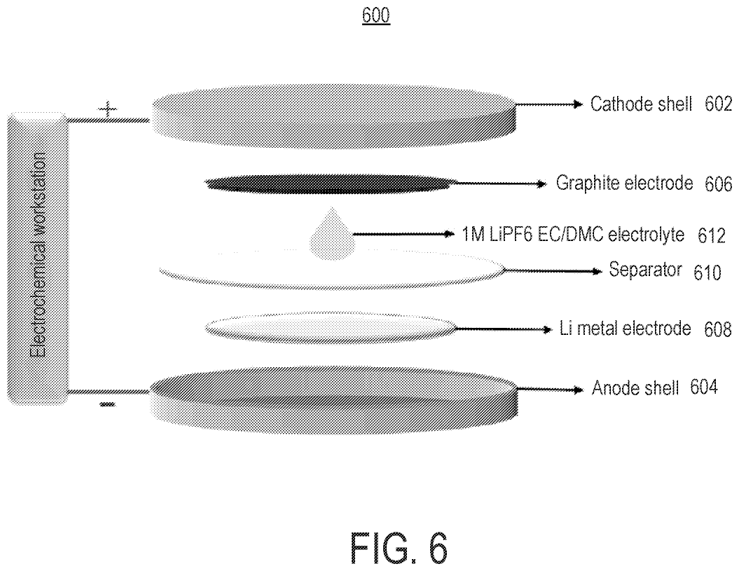

Cycled graphite electrode sample preparation: The cycled graphite coin samples containing the SEI layer were prepared using a graphite Li metal half-cell as shown in FIG. 6. FIG. 6 illustrates a cathode shell 602, an anode shell 604. A graphite electrode 606 can be the working electrode, and an Li metal electrode 608 can be a reference electrode. A separator 610 can optionally be made of Celgard, and can include 30 L of of 1 M LiPF6 EC/DMC electrolyte (LP30) 612 that can be added.

The device 600 shown in FIG. 6 can be constructed in an inert environment (e.g., in the study, all construction steps were done in an Ar-filled glove box). The coin cells were then cycled at the current of 0.14 mA in the voltage range of 0.0010 to 2.0000 V for five cycles. The coin cells were then disassembled inside the glovebox to get the cycled graphite electrode. The cycled graphite electrodes were cut into triangles and loaded on the homemade ambient MS sample holder for ambient MS characterization.

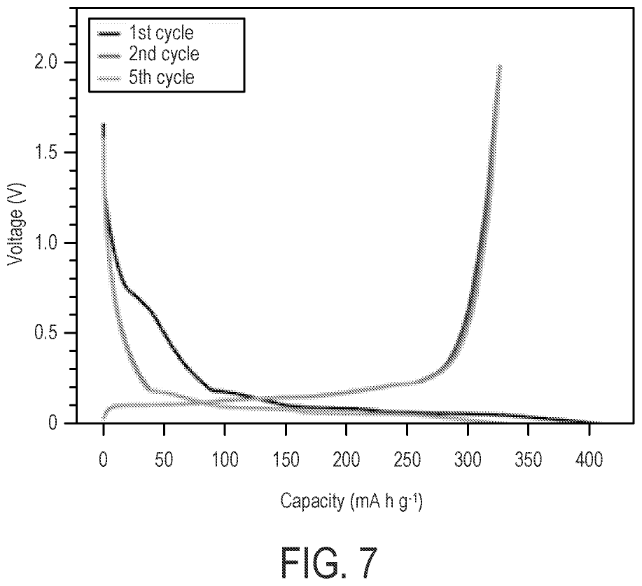

Solvent-free air-tight ambient mass spectrometry: To rapidly characterize the SEI layer of the Li-ion batteries, the study developed an ionization setup called air-tight ambient mass spectrometry displayed in FIG. 2. In this example technique, the study cut the cycled graphite electrode sample into a small triangular shape with a base of ˜3 mm and a height of ˜4 mm with a sharp tip. The sharp tip causes a higher electric field on the tip having a smaller surface area than the triangle's base. There was no additional solvent except the leftover battery electrolyte from the cycling process on the sample surface. An optimized voltage of 1.8 kV for the example implementation applied to the Cu triangle using a copper alligator clip. As shown in FIG. 7, the optimized voltage here was 1.8 kV, but it should be udnerstod that this is only a non-limiting example. The assembly was housed in an air-tight chamber comprising of three inlets. The first inlet allows the passage of a Cu rod that is attached to the sample triangle using a Cu alligator for applying voltage from the MS analyzer power supply. The second inlet is valve 1 which is connected to a pure He gas line from a gas flowmeter The third inlet is Valve 2 which is set between the graphite electrode sample triangle and the MS analyzer inlet. As it is shown in FIG. 2, the first inlet, the graphite electrode sample triangle, and valve 2 are all in-line to each other and also to the MS analyzer inlet whereas the third inlet is right below and orthogonal to the first inlet. The valve 2 has a screw cap that is opened only when the analysis is set to happen and when the gas flow is also on to create a small positive pressure making sure no air or moisture is able to get inside the chamber. The Cu rod holding the graphite electrode sample triangle is pushed forward to be slightly outside of the air-tight chamber and adjusted to be in 2 mm distance to MS inlet. The gas flowmeter allows a gas flow in the range of 1 L to 10 L min-1 to be entered into the air-tight chamber. The whole air-tight chamber is mounted on a moveable stand used for fine adjustment in z-direction for alignment of graphite electrode sample triangle to the MS inlet. No extra solvent, rather than just the battery electrolyte, was on the graphite electrode sample triangle at the time of analysis. All the cutting procedure for making the graphite electrode sample triangle was done in an Ar filled glove box (oxygen<1.5 ppm, H2O<0.5 ppm). 14. Neutral state optimizations were performed. DFT calculations were performed to evaluate the possible conformations for lithium ethylene mono-carbonate (LEMC) in the neutral state. All ground-state geometry optimizations were performed with Gaussian 16[2] and the restricted B3LYP functional.[3.5] The 6-311+G(d,p) basis set was used for all atoms.[6.10] Optimized stationary points were confirmed to be local minima (all real vibrational frequencies) on the potential energy surface using harmonic vibrational frequency analyses. By manually protonation/deprotonation and placement of Lit, eight unique neutral conformations (In. 8n, FIG. 13A and FIG. 13B) were observed. Further analysis of the neutral structures revealed In to be the lowest energy conformation (FIG. 13A and FIG. 13B). To determine the ionization potential (IP) for LEMC, a single point calculation for the doublet cation of In was performed. The IP for In was determined to 221.6 kcal/mol (9.61 eV).

DFT calculations were performed to evaluate the possible conformations for lithium ethylene mono-carbonate (LEMC) in the protonated state. By manual protonation of the neutral forms (1n, 8n), the study was able to generate 9 unique LEMC protomers (1p 9p). Notable observations of the LEMC protomers included (1) the increase in energy of the structures that most closely resembled 1n (1p, 2p, 6p, 7p), (2) the formation of a 7-membered ring as the lowest energy protomer (9p), and (3) 1p, 4p, and 5p protomers that may show fragmentation. To determine the proton affinity of LEMC, acetic acid was used as the proton source and 9p was used as the protonated form of LEMC. The proton affinity of LEMC was estimated to be 112.6 kcal/mol.

For each fragmentation pathway, the “zero-point” was the 9p LEMC protomer. After conformational observations of the protonated species of LEMC, it was determined that 1p, 4p, and 5p were the most likely to fragment. The first possible fragmentation pathway was from the 1p protomer. Possible base elimination of water to led to the 95 m/z peak after loss of water. The formation of the 95 m/z peak was shown to be feasible with a free energy of ˜12.0 kcal/mol. From 1p, two other reaction coordinates were considered: (1) loss of lithium hydroxide (LiOH) or (2) loss of ethylene oxide (EOH followed by EO). The former would lead to the possible formation of protonated ethylene carbonate (ECH, 89 m/z), while the latter would lead to the formation of protonated lithium bicarbonate (LiBCH, 69 m/z). Thermodynamically, the formation of ECH is very unfavorable at ˜67 kcal/mol at the same time the loss of EO is also unfavorable at ˜36 kcal/mol. The highly unfavorable formation of ECH supports the experimental observation that the 89 peak is purely from the ethylene carbonate (EC) solvent at the SEI interphase. After conformational observations of 4p, the next possible fragmentation pathway to 69 m/z was considered. The second possible fragmentation pathway from 4p resulted in the formation of CO2 and lithiated ethylene glycol (LiEG). This fragmentation to form CO2 and LiEG was calculated to be thermodynamically favorable at −16.4 kcal/mol. This observation supports the 69 m/z peak in the experimental spectrum to be formed by the loss of CO2.

Peaks at 157, 183, and 229 were observed in the experimental spectrum. Alluding to the previously derived LEMC fragments of 69 and 95 m/z we sought to derive possible pathways for the formation of 157 and 183 m/z species. The difference in mass balance from the LEMC fragments to 157 and 183 m/z is 88, inferring possible ring opening reactions with EC. The first reaction attempted was from LiEG to IV involving a protonation followed by nucleophilic attack to EC. The formation of IV was shown to be thermodynamically favorable by ˜3.5 kcal/mol, supporting the increase in the intensity of the 69 to 157 m/z peaks. The next reaction was from II to III involving the same protonation, followed by subsequent nucleophilic attack of EC. The formation of III from II was also shown to be thermodynamically favorable by ˜4.5 kcal/mol, supporting the increase in intensity of the 95 to 183 m/z peak. Due to insufficient information about the molecular formula of 229 m/z, we were unable to determine a potential pathway for the formation of this peak

Additional details about the example study are described herein. Materials used in the study included 1M LiPF6 EC/DMC (vol % 50:50) electrolyte (LP30) purchased from Gotion and used directly without further purification. Li chip (0.6 mm thickness) was purchased from MTI. Celgard separator was dried at 70° C. under vacuum using a chemical drier for two days before use. Coin cell cases, graphite electrodes were dried at 120° C. under vacuum using a chemical drier for two days before use. Graphite electrodes contain 80% graphite as the active material, 10% PVDF as the binder, 10% Super P as the conducting material on Cu foil as the current collector. The active material load is 1.2 mg cm-2.

The study included a Thermo Fisher Scientific linear ion trap mass spectrometer (San Jose, CA). Optimized parameters for MS used were as follows: 200° C. capillary temperature, 3 microscans, 100 ms ion injection time, and 60% S-lens voltage. MS data collecting and processing were performed using the Thermo Fisher Scientific Xcalibur 2.2 SP1 software. Tandem MS with collision-induced dissociation was executed for the analyte identification.

Implementations of the present disclosure include synthesis of LEMC.

Inside an Ar-filled glovebox, 8 mL 2.5 M mL n-BuLi/hexane (20 mmol) was dropwise added into 10 mL anhydrous EG. After 30 mins stirring, dry CO2 was bubbled through the previous suspension for 2 hours. Inside the glovebox, 50 mL pyridine was added into the solution. After two days, LEMC as white precipitate was formed, which was separated by centrifuge. The solid powder was washed with DMF and diethyl ether, then dried under vacuum to give the final product.

Implementations of the present disclosure include cycled graphite electrode sample preparation. The cycled graphite coin samples containing the SEI layer were prepared using a graphite-Li metal half-cell, as described herein with reference to FIG. 6. The coin cells were then cycled at the current of 0.14 mA in the voltage range of 0.0010 to 2.0000 V for five cycles. The coin cells were then disassembled inside the glovebox to get the cycled graphite electrode. The cycled graphite electrodes were cut into triangles and loaded on the homemade ambient MS sample holder for ambient MS characterization.

Implementations of the present disclosure include solvent-free air-tight ambient mass spectrometry. To rapidly characterize the SEI layer of the Li-ion batteries, the study discloses an ionization setup called air-tight ambient mass spectrometry displayed in FIG. 1C. In this technique, the study cut the cycled graphite electrode sample into a small triangular shape with a base of ˜3 mm and a height of ˜4 mm with a sharp tip. The sharp tip causes a higher electric field on the tip having a smaller surface area than the triangle's base. There was no additional solvent except the leftover battery electrolyte from the cycling process on the sample surface. An optimized voltage of 1.8 kV (FIG. 9) was applied to the Cu triangle using a copper alligator clip. The assembly was then housed in an air-tight chamber comprising of three inlets. The first inlet allows the passage of a Cu rod that is attached to the sample triangle using a Cu alligator for applying voltage from the MS analyzer power supply. The second inlet is valve 1 which is connected to a pure He gas line from a gas flowmeter The third inlet is Valve 2 which is set between the graphite electrode sample triangle and the MS analyzer inlet. As it is shown in FIG. 1C, the first inlet, the graphite electrode sample triangle, and valve 2 are all in-line to each other and also to the MS analyzer inlet whereas the third inlet is right below and orthogonal to the first inlet. The valve 2 has a screw cap that is opened only when the analysis is set to happen and when the gas flow is also on to create a small positive pressure making sure no air or moisture is able to get inside the chamber. The Cu rod holding the graphite electrode sample triangle is pushed forward to be slightly outside of the air-tight chamber and adjusted to be in 2 mm distance to MS inlet. The gas flowmeter allows a gas flow in the range of 1 L to 10 L min-1 to be entered into the air-tight chamber. The whole air-tight chamber is mounted on a moveable stand used for fine adjustment in z-direction for alignment of graphite electrode sample triangle to the MS inlet. No extra solvent, rather than just the battery electrolyte, was on the graphite electrode sample triangle at the time of analysis. All the cutting procedure for making the graphite electrode sample triangle was done in an Ar filled glove box (oxygen<1.5 ppm, H2O<0.5 ppm).

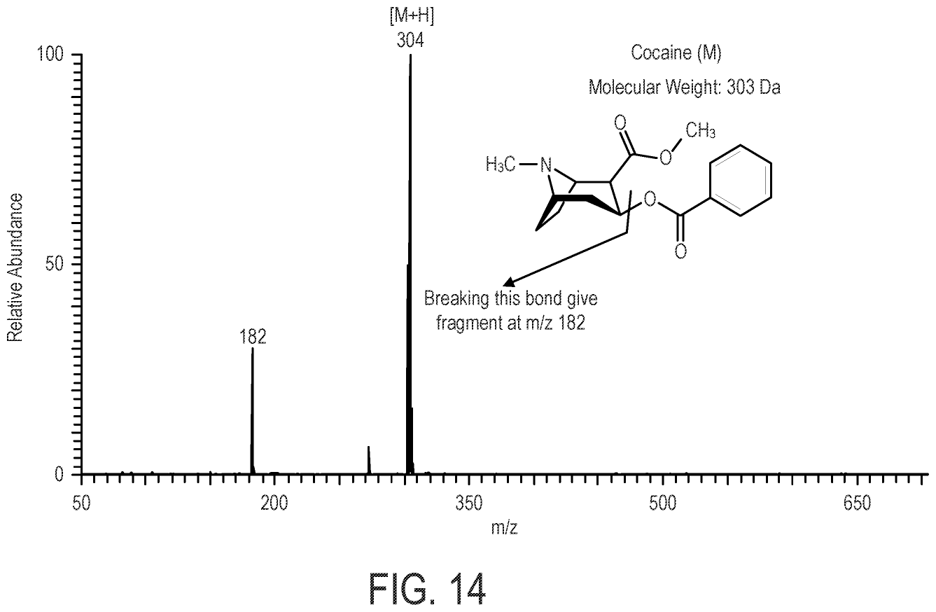

Implementations of the present disclosure can be configured to determine the composition of any air-sensitive materials (e.g., those synthesized in a glove box), including thin-films of organic-based magnetic materials. It should be understood that the devices, systems, and methods are not limited to the analysis of air sensitive materials, and that implementations of the present disclosure can perform the analysis of any other organic compounds under a solvent-free environment. An additional non-limiting example implementation can be used to analyze cocaine present on a copper surface and to determine the molecular weight and structure using ordinary mass spectrometers. An example mass spectrum is shown in FIG. 14, which was recorded on an ion trap mass spectrometer after the cocaine sample was placed on a copper surface and applying 2.1 kV DC voltage. No solvent was used during the analysis, and molecular information indicative of cocaine was observed at m/z 304 and 182.

The following patents, applications, and publications, as listed below and throughout this document, describes various application and systems that could be used in combination the exemplary system and are hereby incorporated by reference in their entirety herein.

### REFERENCES

[1] L. Wang, A. Menakath, F. Han, Y. Wang, P. Y. Zavalij, K. J. Gaskell, O. Borodin, D. Iuga, S. P. Brown, C. Wang, K. Xu, B. W. Eichhorn, Nature Chemistry 2019, 11, 789. 796.
[2] M. Frisch, G. Trucks, H. Schlegel, G. Scuseria, M. Robb, J. Cheeseman, G. Scalmani, V. Barone, G. Petersson, H. Nakatsuji, 2016.
[3] A. D. Becke, The Journal of Chemical Physics 1993, 98, 5648.5652.
[4] P. J. Stephens, F. J. Devlin, C. F. Chabalowski, M. J. Frisch, The Journal of

Physical Chemistry 1994, 98, 11623.11627.
[5] K. Kim, K. D. Jordan, The Journal of Physical Chemistry 1994, 98, 10089.10094.
[6] A. D. McLean, G. S. Chandler, The Journal of Chemical Physics 1980, 72, 5639.5648.
[7] R. Krishnan, J. S. Binkley, R. Seeger, J. A. Pople, The Journal of Chemical Physics 1980, 72, 650.654.
[8] B. Roos, A. Veillard, G. Vinot, Theoretica Chimica Acta 1971, 20, 1.11.
[9] A. J. H. Wachters, The Journal of Chemical Physics 1970, 52, 1033.1036.
[10] K. Raghavachari, G. W. Trucks, The Journal of Chemical Physics 1989, 91, 1062.1065.

What is claimed is:

1. A method comprising:
providing a material in an air-tight chamber defining an inlet and an outlet;
supplying a direct current voltage to an electrode proximate to the material to generate ions in the air-tight chamber;
introducing a carrier gas to the air-tight chamber at the inlet; and
collecting the carrier gas and the ions at the outlet.

2. The method of claim 1, wherein the method further comprises performing a mass spectrometry analysis on the ions collected at the outlet.

3. The method of claim 2, further comprising characterizing, based on the mass spectrometry analysis, an elemental composition and structure of the material.

4. The method of any one of claims 1-3, further comprising determining a chemical composition of solid electrolyte interphase generated from a Lithium-Ion battery.

5. The method of claim 3, wherein the material comprises a thin-film organic-based magnetic material.

6. The method of claim 3, wherein the material comprises small organic compounds.

7. The method of claim 6, further comprising determining a chemical composition of the small organic compounds.

8. The method of claim 7, wherein the small organic compounds comprises an illicit drug.

9. The method of claim 8, wherein the illicit drug is cocaine.

10. The method of claim 7, wherein the small organic compounds is not air sensitive.

11. The method of any one of claims 1-10, wherein the carrier gas is an inert gas.

12. The method of claim 11, wherein the inert gas is helium.

13. The method of any one of claims 1-12, wherein the direct current voltage is approximately 1.8 kV.

14. The method of any one of claims 1-13, wherein the electrode comprises a triangular tip.

15. The method of any one of claims 1-14, wherein the material is triangular.

16. A system for performing direct analysis of a material, the system comprising:
an air-tight chamber defining an inlet and an outlet, wherein the air-tight chamber is configured to hold the material, wherein the inlet is configured to introduce a gas into the air-tight chamber, and wherein the outlet is configured to collect gasses and ions from the air-tight chamber; and
an electrode positioned inside the air-tight chamber and configured to configured to be proximate to the material to generate ions in the air-tight chamber when a direct current voltage is applied to the electrode.

17. The system of claim 16, wherein the system is configured to output the ions collected at the outlet to a mass spectrometer.

18. The system of claim 17, wherein the mass spectrometer is configured to characterize, based on an output of the mass spectrometer, an elemental composition and structure of the material.

19. The system of claim 16 or claim 17, wherein the mass spectrometer is configured to determine a chemical composition of solid electrolyte interphase generated from a Lithium-Ion battery.

20. The system of claim 19, wherein the material comprises a thin-film organic-based magnetic material.

21. The system of any one of claims 16-18, wherein the material comprises small organic compounds.

22. The system of claim 21, wherein the system is configured to determine a chemical composition of the small organic compounds.

23. The system of claim 22, wherein the small organic compounds comprises an illicit drug.

24. The system of claim 23 wherein the illicit drug is cocaine.

25. The system of claim 21 or claim 22, wherein the small organic compounds is not air sensitive.

26. The system of any one of claims 16-25, wherein the direct current voltage is approximately 1.8 kV.

27. The system of any one of claims 16-26, wherein the electrode comprises a triangular tip.

28. The system of any one of claims 16-27, wherein the material is triangular.

29. The system of any one of claims 26-28, wherein the electrode is configured to non-destructively analyze the material.
